(19) United States
(12) Patent Application Publication
(10) Pub. No.: US 2005/0187964 A1
(43) Pub. Date: Aug. 25, 2005

(54) Method and apparatus for retrieving natural language text

(75) Inventors: Takahiro Nakamura, Chiyoda-ku (JP); Hiroshi Aizawa, Chiyoda-ku (JP); Ryoji Watanabe, Tokyo (JP)

Correspondence Address: OSHA LIANG L.L.P., 1221 MCKINNEY STREET, SUITE 2800, HOUSTON, TX, 77010, US

(73) Assignee: Shogakukan, Inc., Tokyo (JP)

(21) Appl. No.: 10/913,807

(22) Filed: Aug. 5, 2004

(30) Foreign Application Priority Data
Feb. 24, 2004 (JP) 2004-047377

(51) Int. Cl. G06F 17/00

(52) U.S. Cl. 707/102

(57) ABSTRACT

A method for retrieving data from a set of natural language texts, includes the steps of storing the units of the natural language texts and fixed-length codes into a conversion-code table relating each unit uniquely to each code; constructing a coded-text database which stores a set of coded texts produced by converting the units of the natural language texts into the relating fixed-length code using the conversion-code table while maintaining information concerning unit order of the natural language texts; and retrieving coded-texts from the coded-text database using the fixed-length code.

### BACKGROUND OF THE INVENTION

1. Field of the Invention

The present invention relates to a method and an apparatus which retrieve text from a set of natural language texts having an enormous amount of data, and are capable of high-speed pattern retrieval utilizing word order and the like. Preferably, the present invention relates to a method and an apparatus which retrieve text from a set of natural language texts expressed in a standard format such as SGML (Standard Generalized Markup Language), XML (eXtensible Markup Language) and the like, and are capable of high-speed retrieval utilizing attributes of the formats, word order and the like.

2. Description of the Related Art

A natural language text which is used on a daily basis and has a function of transferring information among human beings, has a complicated structure in which many words have various forms specified by tense, number, person and the like, and are arranged in various word order. In the case that the amount of a set of natural language texts is relatively small, it is possible to retrieve text using full-text retrieval software such as grep or the like, which can utilize regular expressions concerning word order, various change forms of words, and the like. In this method, however, as the amount of a set of the natural language texts becomes enormous, the retrieval time required also becomes enormous. Thus, this method is not practical in case of enormous amount of text. For example, an Internet retrieval system generally used has a database constructed in advance which relates various keywords to the URLs of the Web pages including the keywords. When a keyword is input in the system, URLs correspond to the keyword are simply retrieved from the database. The actual situation is that it is difficult to provide appropriate high-speed pattern retrieval from a set of natural language texts having an enormous amount of data in consideration of word order, attributes, or the like.

Incidentally, as an example of a set of natural language texts having an enormous amount of data, corpora are known. Corpora are large collections of natural language text of certain levels used in newspaper articles, movie scripts, and the like. In recent years, attention has been focused on a so-called annotated corpus, a corpus with secondary data, which is encoded in a text-based standard data exchange format such as SGML, XML or the like. A corpus with secondary data is a corpus which contains not only natural language text but also secondary data such as a part of speech, an original form of a word and the like as tag attributes for each grammatical unit of the texts such as each word, phrase, chapter, and the like. The British National Corpus (BNC), the Bank of English, and the like are known as examples of corpora with secondary data. Each of these corpora has an enormous amount of data of several gigabytes, and is used for collocation surveys to clarify the customary aspects of linguistic expressions, or for the description of or the analysis of natural linguistic expressions.

However, retrieving natural language text from such a large-scale corpus without the use of secondary data, it is difficult to narrow down the size of retrieval results to the size suitable for the purpose. If a corpus with secondary data is searched using a regular expressions by a full-text retrieval software such as grep or the like, an enormous amount of retrieval time is required. Furthermore, as for the specific formats of many corpora with secondary data adopted, they are adopted for the reason that they are easy to input secondary data in the corpora in many cases. Thus, the formats are not suitable for high-speed retrieval. Therefore, it is desired that it becomes possible to conduct a high-speed retrieval from a corpus with secondary data using the secondary data such as parts of speech, information concerning word order and the like included in the corpus.

As for a method of retrieving texts from structured documents having a certain logical structure, a method of retrieving text from structured documents at a high speed by means of preparing index table in addition to the structure information table, the tag information table, and the text data included in the structured documents has been disclosed in Japanese Unexamined Patent Application Publication No. 08-137898. And as for a method of retrieving text from a corpus with tags, a flexible method of retrieving text from any of the subtrees of a corpus, or retrieving text using a connection relation in a corpus, by means of preparing tables of which each table corresponds to each hierarchy such as a morpheme, a clause, a sentence, a paragraph, and the like included in the corpus, using a Relational Database has been disclosed. This technique is disclosed in a Research Report written by Kudo, Matsumoto, “A Flexible Query Environment for Annotated Corpora using Relational Database,” Journal of Natural Language Processing, No. 144, issued by the Association for Natural Language Processing, 2001. Furthermore, a retrieval apparatus which has an interface capable of intuitively retrieving text from a documents database having a complicated structure and including secondary data, and a method of constructing a database therefore have been disclosed in International Publication WO02/091234 Brochure. However, in any case above mentioned, there are problems that necessary databases for retrieval are very complicated and thus large amounts of works are required for their constructions, or considerable time is required for retrieval or the like.

### BRIEF SUMMARY OF THE INVENTION

It is therefore an object of the present invention is to provide a method and an apparatus capable of high-speed pattern retrieval from a set of natural language texts having an enormous amount of data in consideration of word order, secondary data, and the like. Preferably, the present invention proposes a highly practical method and apparatus capable of high-speed pattern retrieval using secondary data, word order, and the like from a corpus with secondary data.

According to a first aspect of the present invention, the method for retrieving data from a set of natural language texts includes the steps of storing the units of the natural language texts and fixed-length codes into a conversion-code table relating each unit uniquely to each code; constructing a coded-text database which stores a set of coded texts produced by converting the units of the natural language texts into the relating fixed-length code using the conversion-code table while maintaining information concerning unit order of the natural language texts; and retrieving coded-texts from the coded-text database using the fixed-length code.

According to the present invention, high-speed pattern retrieval is possible from a set of natural language texts having an enormous amount of data in consideration of word order, a distance between words and the like. Also, it is easy to construct a retrieval database. When applying the invention to a corpus with secondary data, pattern retrieval using the secondary data becomes possible.

### BRIEF DESCRIPTION OF THE DRAWINGS

FIG. 1 is a conceptual diagram of a part of a conversion-code table.

FIG. 2 is a conceptual diagram of another part of the conversion-code table.

FIG. 3 is a schematic diagram illustrating an example of input fields.

FIG. 4 is a schematic diagram illustrating an example that a search condition is inputted in the input fields.

FIG. 5a to 5c are schematic diagrams illustrating contents of an encoded search condition.

FIG. 6 is a schematic diagram illustrating another example that a search condition is inputted in the input fields.

FIG. 7 is a schematic diagram illustrating another example of an encoded search condition.

FIG. 8 is a schematic diagram illustrating still a further example that a search condition is inputted in the input fields.

FIG. 9 is a schematic diagram illustrating still a further example of an encoded search condition.

FIG. 10 is a schematic diagram illustrating an example that a generalized search condition is inputted in the input fields.

FIG. 11 is a schematic diagram illustrating an example that the inputted generalized search condition is encoded.

FIG. 12 is a block diagram illustrating a general configuration of a retrieval apparatus 1 as viewed from a control aspect.

FIG. 13 is a flowchart illustrating a general flow of retrieval processing.

FIG. 14 is a conceptual diagram illustrating a general configuration of a retrieval system 2.

FIG. 15 is a flowchart illustrating a general flow of patrol processing.

FIG. 16 is a flowchart illustrating a general flow of another retrieval processing.

### DETAILED DESCRIPTION OF THE INVENTION

In the following, a detailed description of the present invention will be given, using English as an example of a natural language, and using a word delimited by spaces as an example of a minimum unit of the language, in order to simplify the description. Also, a natural language text is assumed to be formatted in a markup language standardized on a text basis. And, for secondary data included in the tag attributes of the markup language, a basic form of a word and a part-of-speech classification including conjugations are assumed to be used, in order to simplify the description. These units are sometimes called tokens in the following.

First, an example sentence “I gave up smoking.” is considered. As shown in the following, this sentence is rewritten into an SGML format source text with attributes such as a basic form, a part of speech and the like.

A source text example: <sentence id=1 filename=****.txt><word basic form=I part of speech=pronoun>I <word basic form=give part of speech=verb past tense>gave <word basic form=up part of speech=adverb>up <word basic form=smoke part of speech=verb progressive form>smoking <word basic form=. part of speech=delimiter>.</sentence>

Here, <> denotes a tag, and “word” included in the tag means that the tag concerns a word and so on.

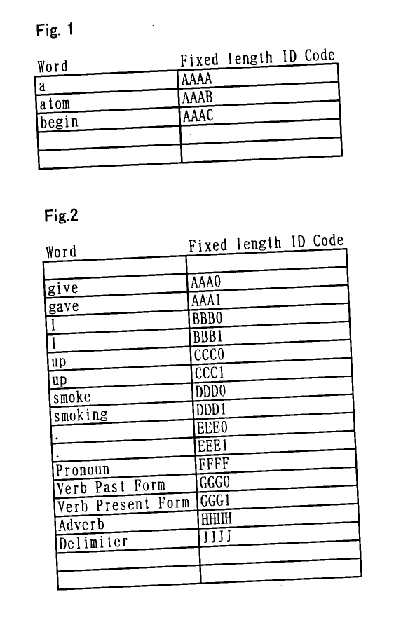

Next, a conversion-code table is created, in which every word, tag attribute, and tag name if necessary, included in the language are related to fixed-length ID codes so as to identify every token uniquely by the code. That is to say, a table is created, in which every word, tag attribute, and tag name used in English sentences are related to fixed-length ID codes one-to-one. FIG. 1 is a example of a part of a conversion-code table created by using 4-byte ASCII codes as fixed-length ID codes. The left column in this table includes all the words, the tag attributes, and the tag names. Also, the right column in the table stores fixed-length ID codes corresponding to the left column with one-to-one relationship.

In this example, the reason for using the 4-byte fixed-length ID code is that this code system has enough capacity which allows to identify every token uniquely such as a word including a basic form and change forms, a part of speech and the like. Four-byte binary data has an ID space of 1 byte (=256) to the fourth power, and can practically accommodate all kinds of words, all kinds of tag attributes and the like used in a single language. That is to say, the length of the fixed-length ID code may be determined such that the number of the fixed-length ID codes exceeds the sum of the number of words, various tag attributes, and tag names which are used in all of the natural language texts stored in the database. Accordingly, the length of the fixed-length ID code is not necessarily limited to four bytes, and the length may be a larger number of bytes, or a smaller number of bytes.

Though an ASCII code system is used in this example, a usable code system is not limited to the ASCII code system. For example, another code system such as the JIS code system or the like can be used which can be handled by a full-text retrieval engine used for retrieval described below. Also, in case that a coded text is inputted in an array, a sequence of integers or a bit string may be used instead.

When a conversion-code table is constructed, the list of words included in source texts may be sorted in ASCII sequence in advance. Then the fixed-length IDs are allocated to the words one by one in ascending order or in descending order of the code value in accordance with the sorted sequence. With this arrangement, the order of the fixed-length IDs corresponds to the sorted order of the words. Thus, when the list is sorted using the fixed-length IDs, the words of the source text are also sorted in ASCII sequence.

FIG. 2 is a diagram illustrating an example of a part of the conversion-code table corresponding to the example of the source text described above. The source text described above is coded to constitute a coded text according to this conversion-code table. The coding is performed so as to maintain the word order information identifying the original order of words including in the natural language text of the source text example. As far as the order information of the word alignment is maintained, the inner order of a word, a basic form, and a part of speech concerning each word may be arbitrary, though the inner order is determined in advance so as to be the same for every word. Here, an example is shown in the following, in which the original inner order of the source text example “basic form/part of speech/word” is changed to the inner order “word/basic form/part of speech”, and the changed source text is then coded. In spite of this change, the word order information in the natural language text is essentially maintained. In the following example, the reason for delimiting each 4 byte-code by a space is to correspond to the fact that many of full-text retrieval engines interpret a space as a delimiter of a word in order to create an index file.

Example of a coded text: BBB1 BBB0 FFFF AAA1 AAA0 GGG0 CCC1 CCC0 HHHH DDD1 DDD0 GGG1 EEE1 EEE0 JJJJ

Here, the beginning “BBB1” of the coded text represents the code of a token whose original form is “I”, the subsequent “BBB0” represents the code of a token whose basic form is “I”, and furthermore “FFFF” represents the code of a token whose part of speech is “pronoun”. These beginning three fixed-length codes make up a group, and correspond to one word “I” positioned at the beginning of the natural language text. The subsequent groups are also made by three codes. Each group corresponds to one word of the text, and has an inner order of tokens such as “word/basic form/part of speech”. Also, the groups made by three codes are arranged in accordance with the word order of the corresponding natural language text. That is to say, in the arrangement of the fixed-length codes of the coded text, the word order information of the natural language text is maintained in accordance with a predetermined way.

As described above, coded texts are constituted by using fixed-length codes for all the natural language text of a set of natural language texts, and then a coded-text database containing a set of such coded texts is constructed. By using the database constructed as described above, it becomes possible to conduct high-speed retrieval in consideration of word order, secondary data and the like, even if the amount of a set of natural language texts is enormous.

In order to maintain the order information of the arrangement of components, the original arrangement may be directly reflected to the arrangement of the fixed-length codes of the coded texts. Alternatively, as described above, the inner order of a group corresponding to one word may be changed to another predetermined inner order. In this case, this same inner order needs to be adopted for all the groups. Also, the word order of the natural language text may be changed in the coded text to another predetermined word order. In this case, the word order of all the coded text needs to be changed from the original word order of the natural language text to the predetermined word order.

Next, a description will be given of a method of retrieving from this coded-text database. As for the software to be used for the retrieval, a full-text retrieval software may be used that has a function of so-called neighborhood retrieval, which allows specification of the number of characters or the distance between keywords used for the retrieval. A fixed-length ID code needs to be used as the input to the retrieval software. However, in this example, words or parts of speech are directly inputted into the input fields, and the inputted data is converted into fixed-length ID codes using the conversion-code table, and then the retrieval is executed.

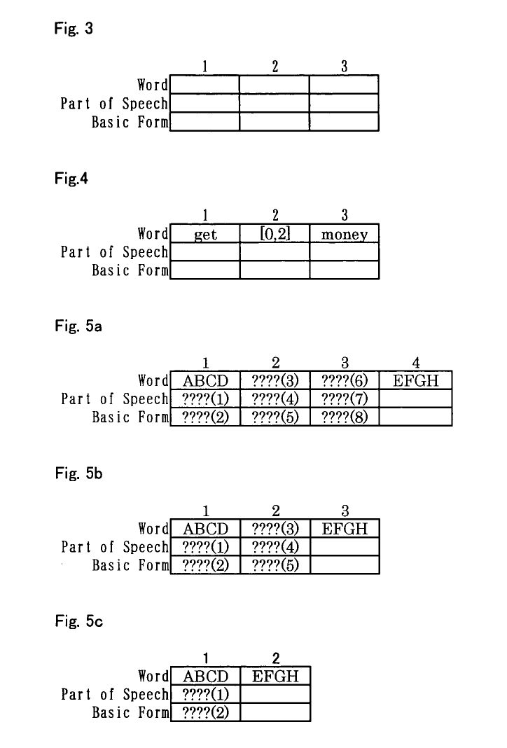

For input to the apparatus, a selection can be made from two input methods. The first method is a method of directly inputting a query. The second method is a method of inputting retrieval data into the input window which has input fields arranged in a tabular form or a matrix, as shown in FIG. 3, which allows to input words or secondary data specifying their arrangement.

When directly inputting a query, for example, the query can be written in accordance with a syntax as described below. First, the contents to be retrieved are aligned in accordance with the order of the corresponding words, and the aligned contents are put in curly braces {} by every word. Next, each content is replaced with a query corresponding to each content one by one. For example, when retrieving natural language text which includes a word “giving” followed by any words in the range of m to n words and then followed by a word “up”, the query can be written as {word=“give” part of speech=“verb progressive form”} [m, n] {word=“up”}. Here, [m, n] means a wild card having a length in the range of m to n words.

By using the input window such as described in FIG. 3, more intuitive input becomes possible. The input window has nine input fields which are arranged in a 3×3 matrix, for example. If one content or more is inputted into any one of these fields, a query as described above is automatically generated using the input data, and the retrieval is executed. The first row of the input fields is the row for inputting words which appear in the natural language text, the second row is the row for inputting parts of speech of the words, and the third row is the row for inputting basic forms of the words. Depending on which row is inputted, by what the retrieval should be conducted is determined. Also, the order of the column indicates the order of the words that appears in the natural language text. The data inputted in the first-column input field is interpreted as the data of the word that appears first in the natural language text, and the data inputted in the second-column input field is interpreted as the data of the word that appears the next, and the data inputted in the third-column input field is interpreted as the data of the word that appears the last. At least one data is inputted into any one of the 3×3 input fields, the retrieval can be executed, and thus very intuitive input becomes possible.

When a search condition is inputted in by any of the ways, the inputted search condition is converted into the corresponding fixed-length ID codes using the conversion-code table described above. Thus a query is constructed, and the retrieval from the coded-text database is executed. Here, a specific example is shown.

Retrieval example 1: A description will be given of an example A=“Retrieve a pattern including “get” followed by two words in maximum, and then followed by “money””. When the search condition is inputted in the input window having the matrix type input fields, “get” is inputted in the first-row and the first-column input field as described in FIG. 4. Thus the texts including “get” as it is in the natural language text become the target of the retrieval. Next, “[0, 2]” is inputted into the first-row and the second-column input field, and then “money” is inputted into the first-row and the third-column input field. In this case, parts of speech and basic forms are not specified, and thus the other input fields are left as undefined. A query is automatically generated from these input data. The query is, for example, {word=“get” part of speech=“ ” basic form=“ ”} [0, 2] {word=“money” part of speech=“ ” basic form=“ ”}. Here, the query parts relate to the part of speech, the basic form and the like which have no content may be omitted in the query.

Next, this query is converted into a query written in the fixed-length ID codes. Here, converting into 4-byte fixed-length ID codes by using the conversion-code table described in FIG. 1 for example, “get” is converted into “ABCD”, and “money” is converted into “EFGH”. Then, the content of the retrieval corresponding to the input data in FIG. 4 is interpreted as the sum of the three contents described in FIGS. 5a, 5b, 5c.

FIG. 5a is the condition for retrieval of the texts which two, arbitrary words exist between the two keywords. FIG. 5b is the condition for retrieval of the texts which one arbitrary word exists between the two keywords. FIG. 5c is the condition for retrieval of the texts which no word exists between the two keywords.

In FIG. 5a, two arbitrary words included in the wild card inputted in the input field in FIG. 4 are converted into the second column and the third column of the matrix in FIG. 5a. And the third column of the input field in FIG. 4 is shifted to the fourth column in FIG. 5a. Here, “????” means a wild card which matches any fixed-length ID code. Also, (n) means a predetermined arrangement order of undefined parts.

Next, the matrix type condition of the retrieval in FIG. 5a is linearized as in the following. “ABCD_????(1)_????(2)_????(3)_????(4)_????(5)_????(6)_????(7)_????(8)_EFGH_” Here, an underline denotes a space. This one-dimensional retrieval key has an arrangement order of tokens such that, the inner order of tokens concerning every word is “word/part of speech/basic form” as in the same manner described above, and the order of the groups is the same order of the word order of the original natural language text. The unit length of each token is the sum of the length of fixed-length ID codes and the length of one space. Thus, when there is an 8-unit length distance between the two retrieval keywords as described in this example, a corresponding retrieval command “ABCD_” fby.40 “EFGH_” is generated, for example, because the 8-unit length distance means (4+1)×8=40 distance. Here, “Key1” fby.N “Key2” is an example of a retrieval command which performs neighborhood retrieval. This command means that “Key1 is followed by N bytes and then followed by Key 2”. In this regard, fby stands for “followed by”. Many full-text retrieval engines are provided with this function which allows to specify the distance between retrieval keywords. The meaning of this retrieval command is as follows: B1=“Search the coded-text database for a pattern in which after “ABCD”, 8 tokens follow, and then “EFGH” comes”.

Next, in the same manner as in the case of FIG. 5a, the retrieval command of FIG. 5b is obtained. The result is, for example, “ABCD_” fby.25 “EFGH_”. The meaning of this retrieval command is as follows: B2=“Search the coded-text database for a pattern in which after “ABCD”, 5 tokens follow, and then “EFGH” comes”. Furthermore, the retrieval command corresponding to FIG. 5c is, for example, “ABCD_” fby.10 “EFGH_”. The meaning of this retrieval command is as follows: B3=“Search the coded-text database for a pattern in which after “ABC”, 2 tokens follow, and then “EFGH” comes”. The sum of these three retrieval commands, B=B1+B2+B3, has the same meaning as A described above.

Accordingly, the same retrieval result can be obtained as retrieving directly from a set of natural language texts, by retrieving from the coded-text database encoded with the fixed-length ID code. Also, in order to count the number of words in the original natural language text constituted by undefined length tokens without using fixed length codes, it has been necessary to retrieve delimiters of words by a sequential match search on all the characters included in the text. However, such a match search processing becomes unnecessary in the case of a retrieval using the coded-text database, because the total code length corresponds to the number of words can be simply calculated.

Also, it becomes possible to conduct a high speed retrieval in consideration of word order, since the token order information included in the source texts is maintained in the coded-text database in a predetermined way. Furthermore, it is also possible to perform a high speed retrieval using secondary data, since the coded-text database includes the secondary data.

There are two methods for obtaining the original natural language text from the coded text retrieved from the coded-text database. A selection of a method can be made depending on the purpose. The first method is a method that the coded text retrieved is decoded in accordance with the conversion-code table. The original natural language text is directly obtained by this reverse conversion. Thus the obtained original texts may be displayed in the KWIC format, for example, or the like as a result of the retrieval. This method is simple and is suitable for the case where only the text-based data are needed to display, such as a retrieval of texts from a corpus with secondary data.

The second method is suitable for the case where there are image data and the like in retrieval data in addition to texts. A description will be given of such a case of conducting retrieval of image data and texts from the Internet. First, a set of natural language text is just the Internet itself. The coded-text database is constructed as a set of coded texts which are encoded into fixed-length ID codes with respect to the natural language text read out from the Internet. Also, an index table is produced in which the URLs of the WEB pages including the original text are stored for each coded text. When a coded text is retrieved from the coded-text database as described above, the URLs of the WEB pages including the natural language text which corresponds to the coded text are read from the index table, and these URLs are displayed as a result of the retrieval. Accordingly, retrieval from the Internet in consideration of word order or the like can be performed at a high speed. If the secondary data concerning the natural language text included in the Web page is contained in the coded-text database, it is easy to perform a retrieval by the secondary data.

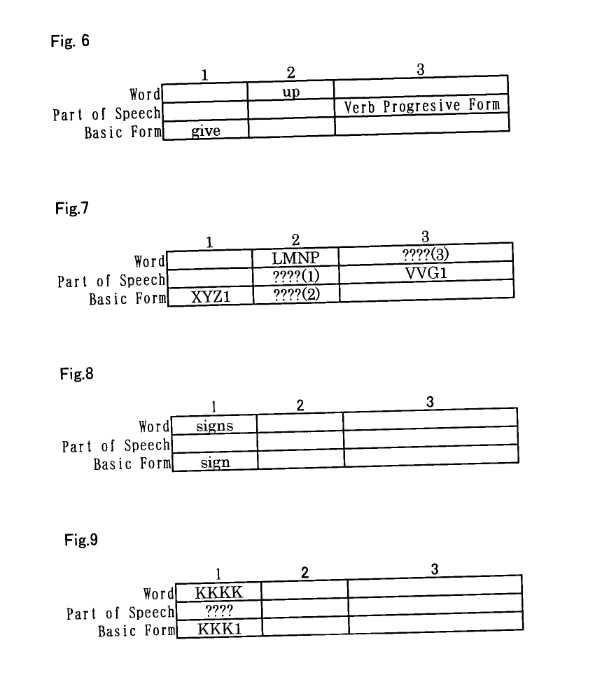

Retrieval example 2: A description will be given of an example C=“Search a set of the natural language texts for a pattern including “give (ignoring conjugation) up”, and directly followed by “-ing form””. The example of inputting this condition C into the input fields arranged in a matrix is shown in FIG. 6. In FIG. 6, “give” is inputted into the field at the first-column and the third-row. Thus, texts including any conjugation of “give” become the target of the retrieval. Also, “up” is inputted into the filed at the second-column and the first-row. Since no other tokens are specified between “give” and “up”, the text including “give up” become the target of the retrieval. Subsequently, “progressive form” is inputted into the field at the third-column and the second-row. Thus, the text including “give up” and directly followed by a progressive form of a verb become the target of the retrieval. The retrieval command generated from the input data is, for example, {basic form=“give”} {word=“up”} {part of speech=“progressive form”}. Here, the command parts correspond to the blank fields are omitted.

Next, each input data in FIG. 6 is converted into the fixed-length ID code using the conversion-code table. The coded matrix is shown in FIG. 7. Here, the coded matrix is obtained under the assumptions that the fixed-length ID code whose basic form is “give” assumes to be “XYZ1”, the fixed-length ID code whose expression used in the original text is “up” assumes to be “LMNP”, and the fixed-length ID code which means progressive form assumes to be “VVG1”. Next, this coded matrix is transformed into one-dimensional key. The result is “XYZ1_LMNP_????(1)_????(2)_????(3)_VVG1_”. Note that the arrangement order of the fixed-length ID code is assumed to be the same as in the case of the retrieval example 1. The length of the undefined parts between “LMNP” and “VVG1” is calculated as (4+1)×3=15, because the length of the fixed-length ID code is 4, the length of a space is 1, and the number of the undefined parts is 3. The example of the retrieval command corresponds to FIG. 7 is “XYZ1_LMNP_” fby.15 “VVG1_”.

This retrieval command means D=“Search the coded-text database for a pattern including “XYZ1_LMNP_”, followed by three tokens, and then “VVG1” appears”. Thus, the meaning of D is the same as that of C. When the coded text is retrieved by the above mentioned command as a result, the original natural language text can be obtained by decoding the coded text using the conversion-code table in the same manner as described in the first method of the retrieval example 1. Alternatively, in the same manner as described in the second method of the retrieval example 1, the URLs of the WEB pages including the natural language text may be identified through the index table.

Retrieval example 3: A description will be given of an example E=“Search a set of the natural language texts for a pattern including a word whose basic form is “sign” and appears as “signs” in the natural language texts”. The search condition E is inputted into the input fields arranged in a matrix as shown in FIG. 8. Inputting “signs” into the field at the first-column and the first-row, text including “signs” as it is in the natural language text become the target of the retrieval. Also, “sign” is inputted into the field at the first-column and the third-row. Thus, the text including a word whose basic form is “sign” become the target of the retrieval. This search condition is converted into the fixed-length ID codes using the conversion-code table. The converted search condition is shown in FIG. 9. Here, the fixed-length ID code corresponding to “signs” which appears as it is in an natural language text is assumed to be “KKKK”, and the fixed-length ID code corresponding to the basic form “sign” is assumed to be “KKK1”. Transforming the search condition shown in FIG. 9 into one-dimensional key, the result is “KKKK_????_KKK1_”. The length of undefined part whose input data is blank is calculated as (4+1)×1=5, and thus the retrieval command becomes “KKKK_” fby.5 “KKK1_”. This means F=“Search for a pattern including “KKKK”, followed by one token, and then “KKK1” comes”. This meaning of F is the same as that of E. Searching the coded-text database by this retrieval command, a desired result can be obtained. Thereafter, the natural language text are obtained from the result in the same manner as described in the retrieval example 1.

Next, a description will be given of a method for retrieval generalized from the examples described above. First, a condition for retrieval from a set of natural language texts with secondary data is assumed to be a pattern such as “xxxxxxxx undefined yyy undefined zzzzzz undefined 1111111”. Here, the reason why the parts of the pattern such as “xxxxxxxx”, “yyy” and the like have various lengths is based on the fact that the lengths of words constituting natural language text vary from word to word.

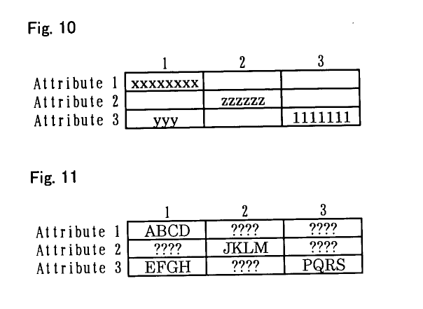

This pattern is inputted into the input fields as shown in FIG. 10. This input data is converted into the fixed-length ID codes using the conversion-code table. The example of the converted pattern is shown in FIG. 11. Transforming the converted pattern of FIG. 11 into one-dimensional key while the token arrangement order of the matrix is maintained, the result “ABCD_????_EFGH_????_JKLM_????_????_????_PQRS_” is obtained. Thus, the retrieval command becomes “ABCD_” by.5 “EFGH_” fby.5 “JKLM_” fby.15 “PQRS_”, for example. Searching the coded-text database by this retrieval command, a desired result can be obtained at a high speed.

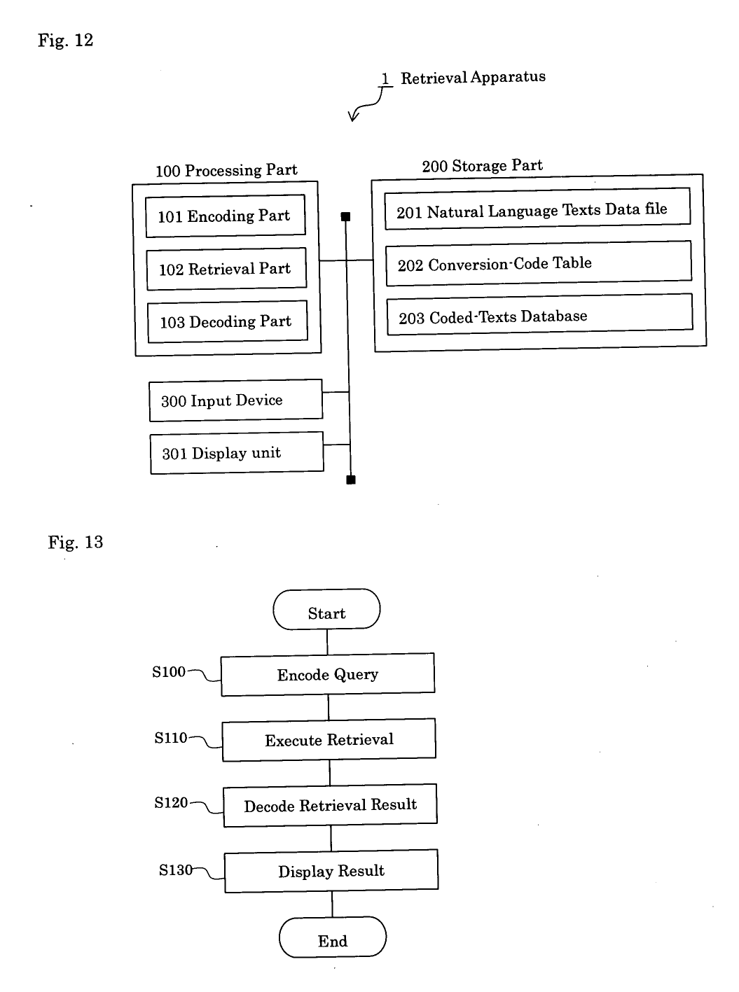

Next, a description will be given of a retrieval apparatus for performing the retrieval method described above. FIG. 12 is a diagram illustrating a general configuration of a stand-alone type retrieval apparatus 1 viewing from a control aspect.

The apparatus 1 is suitable for retrieving from a corpus with secondary data. This retrieval apparatus 1 is constituted on a personal computer for general use. The retrieval apparatus 1 is constructed with a storage part 200 which has a hard disk storing various programs and data, and a processing part 100 which includes a central processing unit CPU and a RAM for temporarily storing the various programs and data read from the storage part 200. The retrieval apparatus 1 has input devices 300 such as a keyboard, a mouse and the like, and a display unit 301 which displays operation procedure on a screen. The apparatus also has a printer, a router, and the like, if necessary.

Here, the storage part 200 may be constructed with a large capacity physical memory without a hard disk. In this construction, all the indexes can be implemented with just tables and arrays, and a full-text retrieval engine for a hard disk becomes unnecessary. In this case, the fixed-length ID should be 32-bit length. In this way, high-speed retrieval can be achieved, though the cost of the apparatus increases. Here, a physical memory mentioned above means a storage device capable of reads/writes data with no mechanical motion, such as a RAM, a flash memory or the like, and does not mean a storage device which reads/writes data with mechanical motion, such as a hard disk or a CD-ROM.

Alternatively, the processing may be performed using a hard disk as the storage part 200 and also using a large capacity physical memory as the RAM of the processing part 100. All of the programs and data which are necessary for retrieval stored on the hard disk of the storage part 200 are read onto the physical memory beforehand and then processed. In this way, all the indexes can also be implemented with tables and arrays, thus high-speed processing becomes possible. In this case, not only the retrieval processing, but also the processing for converting the natural language text into the fixed-length codes may be performed on the physical memory.

The storage part 200 stores a natural-language-text data file 201, a conversion-code table 202, a coded-text database 203, and various programs necessary for screen control and for the other operations. The natural-language-text data file 201 is a set of the text files of a natural language expressed in a text-based markup language such as SGML, XML, or the like. Here, the data file 201 stores a corpus with secondary data which is expressed in SGML for example.

The conversion-code table is a table in which all tokens, such as the words, tag attributes, and tag names, if necessary, that compose the corpus are stored relating to 4-byte fixed-length ID codes in order to identify each token uniquely. The example has already been shown in FIG. 1.

The coded-text database 203 includes: a set of coded texts generated by converting the tokens of the corpus with secondary data into the fixed-length ID codes in accordance with the conversion-code table 202, while maintaining the order information concerning the arrangement of tokens in the corpus; and an index table thereof.

The processing part 100 includes an encoding part 101, a retrieval part 102 and a decoding part 103. The encoding part 101 converts the natural language text stored in the natural-language-text data file 201 into coded texts in accordance with the conversion-code table 202 while maintaining the order information concerning the arrangement of the tokens in the corpus, and stores the coded text into the coded-text database 203, and produces an index table. This processing is carried out at any time when a new corpus is implemented in the apparatus, or when new natural language texts are added to the stored corpus.

The retrieval part 102 searches the coded-text database 203 in accordance with the inputted search condition. The decoding part 103 converts the coded text obtained from the search into the natural language text. A description will be given of the operations of the retrieval part 102 and the decoding part 103 using the flowchart of FIG. 13. Inputting the search condition into the input window, and starting the retrieval operation, the retrieval part 102 encodes the inputted search condition such as the expression of the words and the conjugations etc. concerning tag attributes into the fixed-length ID codes in accordance with the conversion-code table 202. And then, the retrieval part 102 converts the encoded search condition into a retrieval command at the step S100. Next, the coded-text database 203 is searched using this retrieval command, and the coded-texts which match the search condition are obtained at the step S110. Next, the decoding part 103 converts the obtained coded text into the natural language text in accordance with the conversion-code table 202 at the step S120, while the information of token order is maintained in accordance with the same conversion way as used in the encoding part 101 but in reverse direction. Subsequently, this obtained natural language texts are displayed onto the screen of the display unit 301 arranged in the KWIC format, at the step S130. Thus, the processing is terminated.

Processing in this way, it becomes possible to perform a retrieval from an annotated corpus or a set of natural language texts with secondary data having an enormous amount of data in a relatively short retrieval time, conducting the retrieval using secondary data or word order. Accordingly, it is possible to narrow down the retrieval result sufficiently in a relatively short time. Thus, this method is highly practical.

This retrieval apparatus is an example of a stand-alone configuration. This retrieval apparatus may be configured as a server and storage devices, and a retrieval system may be configured such that the server and a plurality of clients can be connected over the Internet, and the clients can retrieve data from a corpus with secondary data and the like. In this case, a search condition is inputted at the client sides, and natural language text retrieved is displayed also on the client screens.

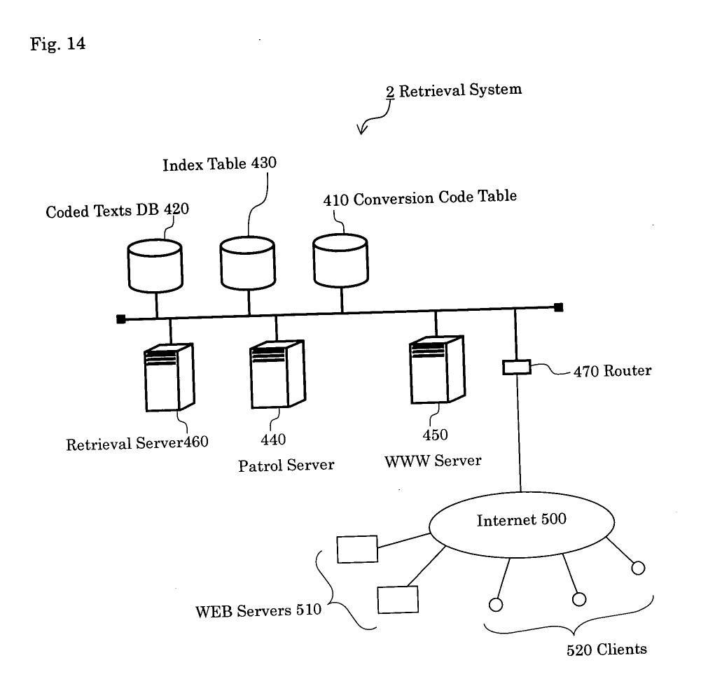

Next, a description will be given of a retrieval system 2 suitable for retrieving data from the Internet construing the Internet as a set of natural language texts. The general configuration of the retrieval system 2 is illustrated in FIG. 14. The retrieval system 2 includes a storage device 410 storing a conversion-code table, a storage device 420 storing coded-text database, a storage device 430 storing an index table, a patrol server 440, a WWW server 450, a retrieval server 460, and a router 470. These devices and servers are connected with each other through a LAN. Also, the retrieval system 2 is connected to the Internet 500 through the router 470.

The conversion-code table 410 is a similar table as the table shown in FIG. 1. The conversion-code table 410 is a table in which fixed-length ID codes are uniquely assigned to all the various words and the secondary data that appear in source text described in HTML (Hyper Text Markup Language) and transmitted from Internet WEB servers 510. Here, HTML is a simplified markup language based on SGML. This table is updated by the patrol server 440 at any time.

The coded-text database 420 is a database which stores the coded text and the IDs thereof in a large scale. The coded texts are produced by converting the source text in accordance with the conversion-code table 410 maintaining the order information concerning the arrangement of tokens in the source texts. The IDs are also expressed in the fixed-length codes. This table is updated by the patrol server 440 at any time.

The index table 430 is a table in which the URLs of the VVEB pages including the coded text and the IDs of the coded text are stored, relating each URL to the IDs of the coded text whose source text are included in the VVEB page identified by the URL. This table is also updated by the patrol server 440 at any time.

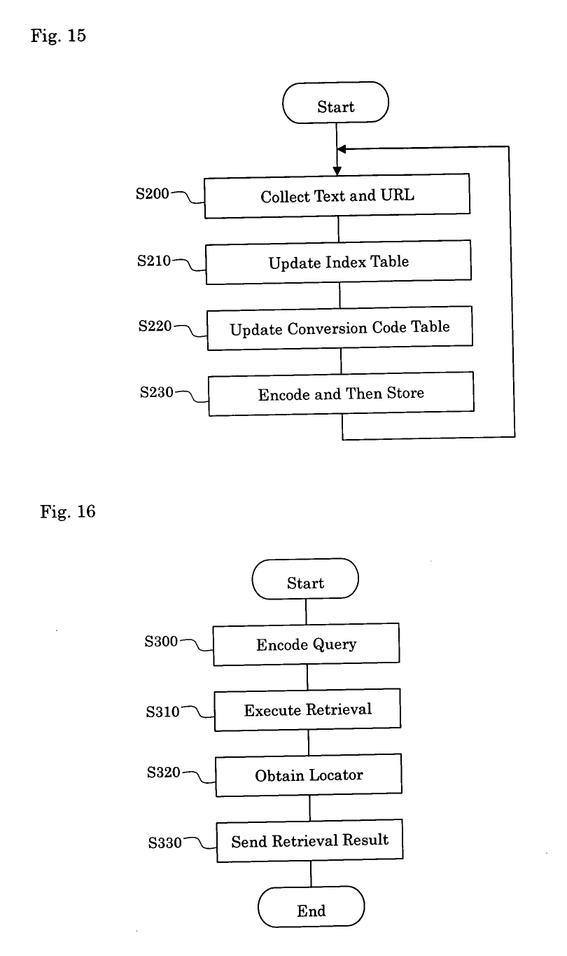

The patrol server 440 has functions of automatically patrolling a plurality of the WEB servers 510 on the Internet, collecting necessary data for retrieval, and updating the databases and the like. A description will be given of the processing of the patrol server 440 using the flowchart in FIG. 15. The patrol server 440 collects the URLs of the WEB servers and the source texts transmitted from the WEB servers, at the step S200. Next, the patrol server 440 adds the collected data to the index table to update, at the step S210. In case that a new token is included in a collected text, but not included in the conversion-code table 410, the patrol server 440 issues a new fixed-length ID code, and adds the ID code to the conversion-code table 410 relating the code to the new token, at the step S220. Next, the patrol server 440 converts the collected text in accordance with the conversion-code table 410, and adds the result to the coded-text database 420. Thus, the necessary data for retrieving natural language texts has been prepared.

When the WWW server 450 receives a request to send the data for the WEB page from a client terminal 520 through the Internet, the WWW server 450 serve the data in HTML necessary for the WEB page for retrieval to the client. Receiving a search condition sent from the client terminal 520, the WWW server 450 transmits the search condition to the retrieval server 460. Receiving a retrieval result from the retrieval server 460, the WWW server 450 processes data for the WEB page which displays the retrieval result, and sends it to the client terminal 520.

The retrieval server 460 conducts a retrieval using the search condition sent from the WWW server 450. A description will be given of this processing using the flowchart in FIG. 16. Receiving the search condition, the retrieval server 460 converts tokens included in the condition into fixed-length ID codes using the conversion-code table 410, and generates a retrieval command, at the step S300. Next, the retrieval server 460 searches the coded-text database 420 using the retrieval command, at the step S310. Retrieving the coded texts, and obtaining the IDs of the coded texts, the retrieval server 460 obtains the URLs of the WEB pages in which the coded texts are used, from the index table 430, at the step S320. The retrieval server 460 sends a set of the URLs obtained to the WWW server at the step S330, thus the retrieval procedure is terminated.

With this constitution, it becomes possible to perform high-speed retrieval of the texts which are open to the public on the Internet using word order and the like from a client. The constitution of the databases is relatively simple, and thus the construction of the databases is easy.

The scope of the present invention is not limited to specific aspects which have been described above concerning some embodiments of the present invention. For example, the natural language text is not limited to be written in English, and may be written in any other language such as Japanese or the like. Also, a unit or a token of a natural language text is not limited to a word, it may be a unit such as a phrase, a combination of a noun or a verb with a particle or an auxiliary verb, and the like. Also, the words may not be delimited by a space. It is enough that a minimum grammatical unit can be specified by a grammatical analysis or the like suitable for each language. The secondary data is not limited to the data related to grammar such as a part of speech, conjugation or the like. The secondary data may include the meanings of a word, a document name and a chapter name included in the natural language text, and related information of the natural language text such as an author name, written date, a publishing company name, a classification item, and the like. Also, it is convenient to use regular expressions in the data of a search condition, though it is also possible to use character information only in the data of a search condition. Also, the configuration of the input window is not limited to the 3×3 matrix input fields as mentioned above, but a more user-friendly window can be adopted.

The method of collecting text by a patrol server from WEB servers may be a method which collects text positioned before and after each keyword within the limited number of characters located here and there in the Internet maintaining the word order of the texts. Or, the method of collecting texts may be a method which collects a full text including each keyword from the Internet. Also, the retrieval system 2 may be constructed to perform retrieval not using the Internet but using a database which accumulates a large scale natural language text and is connected with the system through a LAN or a WAN. As examples of a set of natural language texts, public or non-public databases for patent specifications, various research reports or the like are exemplified.

Also, the retrieval apparatus may be expressed as a program executing on a computer. The program may be stored in a computer-readable recording medium. Here, the program may be divided into some parts based on their functions, and each part may be stored in different recording medium. Here, a recording medium means a transportable medium such as a flexible disk, a magnetic optical disk, a ROM, a CD-ROM, a flash memory and the like, and a hard disk device and the like.

1. A method for retrieving data from a set of natural language texts, the method comprising the steps of:
storing the units of the natural language texts and fixed-length codes into a conversion-code table relating each unit uniquely to each code;
constructing a coded-text database which stores a set of coded texts produced by converting the units of the natural language texts into the relating fixed-length code using the conversion-code table while maintaining information concerning unit order of the natural language texts; and
retrieving coded-texts from the coded-text database using the fixed-length code.

2. A method for retrieval according to claim 1, further comprising a step of:
converting the retrieved coded-texts into natural language texts using the conversion-code table while maintaining the information concerning unit order of the coded-texts.

3. A method for retrieval according to claim 1, further comprising a step of:
obtaining the locators of the natural language texts corresponds to the retrieved coded-texts using an index table in which stores the locators of the natural language texts.

4. A method for retrieval according to claim 1, wherein the natural language text is expressed in a standardized data format including secondary data, and the unit includes the secondary data.

5. An apparatus for retrieving data from a set of natural language texts, the apparatus comprising:
a conversion-code table which stores the units of the natural language texts and fixed-length codes relating each unit uniquely to each code;
a coded-text database which stores a set of coded texts produced by converting the units of the natural language texts into the relating fixed-length code using the conversion-code table while maintaining information concerning unit order of the natural language texts; and
a retrieval part which retrieves coded-texts from the coded-text database using the fixed-length code.

6. An apparatus for retrieval according to claim 5, further comprising:
a decoding part which converts the retrieved coded-text into natural language texts using the conversion-code table while maintaining information concerning unit order of the coded-texts.

7. An apparatus for retrieval according to claim 5, further comprising:
an index table which stores the locaters of the natural language texts corresponds to the coded texts; and the retrieval part which obtains the locaters of the natural language texts corresponds to the retrieved coded-texts using the index table.

8. An apparatus for retrieval according to claim 5, further comprising:
an encoding part which converts the natural language texts into the coded-texts using the conversion-code table while maintaining information concerning unit order of the natural language texts.

9. An apparatus for retrieval according to claim 5, wherein the natural language text is expressed in a standardized data format including secondary data, and the unit includes the secondary data.
